(19) United States
(12) Patent Application Publication
(10) Pub. No.: US 2007/0243479 A1
(43) Pub. Date: Oct. 18, 2007

(54) Electrostatic latent image carrier, electrostatic latent image developer and image forming apparatus

(75) Inventors: Koutarou Yoshihara, Minamiashigara-shi (JP); Masahiro Takagi, Minamiashigara-shi (JP); Satoshi Inoue, Minamiashigara-shi (JP); Yosuke Tsurumi, Minamiashigara-shi (JP); Moegi Iguchi, Minamiashigara-shi (JP)

Correspondence Address: OLIFF & BERRIDGE, PLC, P.O. BOX 19928, ALEXANDRIA, VA, 22320, US

(73) Assignee: FUJI XEROX CO., LTD., TOKYO (JP)

(21) Appl. No.: 11/581,031

(22) Filed: Oct. 16, 2006

(30) Foreign Application Priority Data
Apr. 12, 2006 (JP) 2006-109717

(51) Int. Cl. G03G 9/113; G03G 9/107

(52) U.S. Cl. 430/110.3; 430/111.35; 430/111.33

(57) ABSTRACT

An electrostatic latent image carrier having core particles and a resin coating layer that coats the surface of the core particles, wherein the surface roughness of the core particles exhibits a surface roughness Sm that satisfies the expression Sm≦2.0 μm and a surface roughness Ra (compliant with JIS B0601) that satisfies the expression Ra≧0.1 μm, the surface roughness Ra (compliant with JIS B0601) of the electrostatic latent image carrier satisfies the expression Ra≦0.5 μm, and a sphericity of the electrostatic latent image carrier is 0.975 or higher. In addition, an electrostatic latent image developer that includes a toner and a carrier, wherein the carrier is the electrostatic latent image carrier described above.

### BACKGROUND

1. Technical Field

The present invention relates to an electrostatic latent image carrier and an electrostatic latent image developer used in an electrophotographic method and in electrostatic recording.

2. Related Art

In an electrophotographic method, an electrostatic latent image is formed on a latent image holding member (a photoreceptor) by charging and exposure processes, this electrostatic latent image is developed with toner, the developed image is transferred to a transfer target material, and fixing of the image is conducted by heating or the like, thus forming the final image. Developers that can be used in this type of electrophotographic method can be broadly classified into one-component developers, in which a toner formed by dispersing a colorant within a binder resin is used alone, and two-component developers that are formed from a combination of the above type of toner and a carrier. Because the carrier performs the functions of charging and transportation, two-component developers offer excellent control, and are consequently in widespread use. A feature of two-component developers is the separation of the developer functions, with the carrier performing the functions of stirring, transportation and charging of the developer, and because this separation yields more favorable control, two-component developers are currently in widespread use.

In recent years, digitization processing has been employed as a technique for achieving higher levels of image quality, and such digitization has enabled more complex images to be processed rapidly. Furthermore, although a laser beam is used in the process of forming the electrostatic latent image on the latent image holding member, recent developments in exposure techniques using small-scale laser beams have enabled the formation of more finely detailed latent images. As a result of these types of image processing techniques, electrophotographic methods are gradually expanding into fields such as convenience printing. Modern electrophotographic apparatus also face continued demands for increased speeds and reductions in the size of the apparatus. Particularly in the case of full color images, high quality printing with image quality similar to that of silver halide photography is desirable. Accordingly, in order to enable more finely detailed latent images to be faithfully visualized over extended periods, maintaining the charge of the developer is very important. In other words, further improvements are required in the charge retention properties of the carrier that performs the charging function.

Furthermore, toner particles have been reduced in size in order to yield higher image quality, and toners that include a low melting point wax or the like are used to enable the fixed image to be drawn or written on with a pen or the like. Particularly in the case of full color toners, toners in which a resin with a low softening point and a low melting point wax have been incorporated within the binder resin are widely used to improve the color reproducibility and coloring properties of the toner. During charging of the developer, the desired charge quantity is obtained by frictional charging between the toner and the carrier, but when this type of toner is used, the toner component is prone to becoming spent on the carrier surface as a result of factors such as friction between the toner and the carrier, collisions between carrier particles, and mixing and temperature increases inside the developing unit. This causes problems to arise, including a deterioration in the ability of the carrier to impart charge to the toner and a subsequent increase in the quantity of low-charge toner, which may lead to toner fogging within areas outside of the latent image, as well as an increase in contamination within the developing unit with ongoing use of the apparatus. Furthermore, in the case of a toner that includes a wax or a low softening point resin, stress may cause additives that have been added to the toner to become buried within the toner surface, meaning they are unable to perform their intended functions. Examples of problems that may arise include a deterioration in the image quality caused by image roughening that arises from a reduction in toner fluidity, a deterioration in the developing characteristics, or a deterioration in the transfer characteristics.

In order to improve the charging stability and extend the lifespan of the charge, various investigations have been conducted into carrier coating layers. From the viewpoint of improving the spent resistance, investigations have focused on fluororesins, silicone-based resins and polyolefin-based resins that exhibit excellent releasability. Coated carriers that employ these types of high releasability resins have certainly proven to be an effective tool in extending the lifespan of the charge. However, in order to target further improvements in the lifespan of the charge, the coating layer needs to be made structurally thicker. In such cases, the carrier develops high resistance, making it unable to undergo rapid charge exchange under conditions of low temperature and low humidity, and causing a deterioration in the initial charge-up. This leads to a deterioration in the charge-up and toner addition characteristics, causing the toner charge distribution to widen. As a result, the image density falls, and scattering and fogging of the low charge toner occurs. Furthermore, edge effects caused by the carrier resistance also arise.

Furthermore, burying of the aforementioned additives, namely external additives, and the aforementioned problem of the toner component becoming spent are caused by collisions or friction between the toner and the carrier. Accordingly, tests have been conducted into addressing this problem by investigating the shapes of the core particles within the carrier and the carrier particles themselves. In particular, roughnesses are being conducted into techniques in which a core material with an uneven surface is used as the core material within the above core particles.

### SUMMARY

As a result of detailed investigations of the problems described above, the inventors of the present invention discovered that by adopting the configuration of the present invention described below, the effects described above could be achieved, and they were thus able to complete the present invention.

According to an aspect of the present invention, there is provided an electrostatic latent image carrier having core particles and a resin coating layer that coats the surface of the core particles, wherein the surface roughness of the core particles exhibits a surface roughness Sm that satisfies the expression Sm≦2.0 μm and a surface roughness Ra (compliant with JIS B0601) that satisfies the expression Ra≧0.1 μm, the surface roughness Ra (compliant with JIS B0601) of the electrostatic latent image carrier satisfies the expression Ra≦0.5 μm, and the sphericity of the electrostatic latent image carrier is 0.975 or higher. Ra is also referred to as the “centerline average roughness”.

### BRIEF DESCRIPTION OF THE DRAWINGS

Embodiment(s) of the present invention will be described in detail based on the following figures, wherein:

FIG. 1 is a schematic illustration showing a sample configuration of an image forming apparatus that uses an image forming method of the present invention to form an image; and

FIG. 2 is a laser microscope photograph showing particle surfaces.

### DETAILED DESCRIPTION

As follows is a more detailed description of the present invention.

### [Electrostatic Latent Image Carrier]

As follows is a description of an electrostatic latent image carrier of the present invention. In the following description, the term “electrostatic latent image carrier” may be abbreviated as simply “carrier”.

A carrier of the present invention has core particles and a resin coating layer that coats the surface of the core particles, wherein the surface roughness of the core particles exhibits a surface roughness Sm that satisfies the expression Sm≦2.0 μm and a surface roughness Ra (compliant with JIS B0601) that satisfies the expression Ra≧0.1 μm, the surface roughness Ra (compliant with JIS B0601) of the electrostatic latent image carrier satisfies the expression Ra≦0.5 μm, and the sphericity of the electrostatic latent image carrier is 0.975 or higher. Ra is also referred to as the “centerline average roughness”.

In the present invention, measurement of Ra and Sm is conducted in accordance with JIS B0601. In the examples described below, measurements are conducted using the measuring device described below.

The sphericity is measured using the LPF measurement mode of a FPIA-3000 device (manufactured by Sysmex Corporation). To conduct the measurement, 0.03 g of the carrier is dispersed in a 25% by weight aqueous solution of ethylene glycol, and the average sphericity is determined by analyzing particles other than those with a particle size of either less than 10 μm or greater than 50 μm.

In the present invention, the raw material for the core particles prior to baking is ground more finely than in conventional production methods, thereby increasing the packing ratio within the core particles of the raw material, and the temperature is also applied more uniformly during the baking stage, enabling a more uniform surface to be obtained. Moreover, the core particles of the present invention can be prepared by controlling the crystal growth by grinding and dispersing the raw material more finely, and applying the temperature in a uniform manner. One method that can be used to apply a uniform temperature involves the use of a rotary kiln.

Although any of the conventionally used materials can be used as the core particles, the use of either ferrite or magnetite is particularly desirable. Examples of other known core particles include iron powder. Because iron powder has a large specific gravity, it is more likely to cause deterioration of the toner, and consequently ferrite and magnetite offer higher levels of stability. Examples of ferrite include the materials represented by the general formula shown below.

(MO)_{X}(Fe₂O₃)_{Y}

(wherein, M includes at least one metal selected from a group including Cu, Zn, Fe, Mg, Mn, Ca, Li, Ti, Ni, Sn, Sr, Al, Ba, Co and Mo; and X and Y represent molar ratios, wherein X+Y=1.00)

Ferrite particles in which the aforementioned M is one or more metals selected from a group including Li, Mg, Ca, Mn, Sr and Sn, and the quantity of any other components is no higher than 1% by weight are preferred. If Cu, Zn or Ni elements are added, then the resistance is more likely to be low, making the ferrite prone to charge leakage. Furthermore, the ferrite also tends to become more difficult to coat, and the environmental dependency also tends to deteriorate. In addition, because these elements are heavy metals, the stress applied to the carrier tends to increase, which may have an adverse effect on the lifespan of the carrier. Furthermore, from the viewpoint of safety, ferrites that include added Mn or Mg have recently become widespread. A ferrite core material is ideal, and the raw materials for the core particles include Fe₂O₃ as an essential component, together with the magnetic fine particles that are incorporated within the fine magnetic particle-dispersed resin core, examples of which include ferromagnetic iron oxide powders such as magnetite and maghemite, spinel ferrite powders that contain one or more metals other than iron (such as Mn, Ni, Zn, Mg and Cu), magnetoplumbite ferrite powders such as barium ferrite, and fine particulate powders of iron or iron alloys that are surface-coated with an oxide film.

Specific examples of the core particles include iron oxides such as magnetite, γ-iron oxide, Mn—Zn ferrite, Ni—Zn ferrite, Mn—Mg ferrite, Li ferrite, and Cu—Zn ferrite. Of these, the low cost magnetite is particularly favorable.

In those cases where a ferrite core material is used as the core particles, an example of a suitable production method for the ferrite core material involves first blending appropriate quantities of each of the oxides, subsequently grinding and mixing the oxides for 8 to 10 hours in a wet ball mill, drying the resulting mixture, and then conducting preliminary baking in a rotary kiln or the like at a temperature of 800 to 1,000° C. for a period of 8 to 10 hours. Subsequently, the prebaked product is dispersed in water, and ground in a ball mill or the like until the average particle size falls with in a range from 0.3 to 1.2 μm. The resulting slurry is granulated and dried using a spray dryer or the like, subsequently held at a temperature of 800 to 1,200° C. for a period of 4 to 8 hours under a controlled oxygen concentration environment in order to regulate the magnetic properties and resistance, and then ground and classified to yield the desired particle size distribution. In the present invention, the use of a rotary electric kiln is desirable in terms of achieving a uniform shape for the surface of the core particles.

The surface roughness of the core particles used in the present invention exhibits a surface roughness Sm that satisfies the expression Sm≦2.0 μm and a surface roughness Ra (compliant with JIS B0601) that satisfies the expression Ra≧0.1 μm. Prescribing the surface roughness of the core particles in this manner eliminates internal voids, yielding core particles with irregularities only at the particle surface. By employing core particles with this type of structure, a resin coating layer with a high coating ratio can be formed, meaning reductions in the charge-imparting ability of the carrier can be suppressed. Furthermore, by using core particles of the above prescription, reductions in the level of magnetism can be alleviated, the transportation properties of the resulting carrier can be improved, and magnetic permeability-based toner density control can also be improved.

Furthermore, if the surface roughness of the core particles is such that the surface roughness Sm exceeds 2.0 μm, then during production of the core particles, voids are more likely to develop inside the core particles, increasing the likelihood of difficulties arising in the subsequent formation of the resin coating layer. Furthermore, if the surface roughness Ra (compliant with JIS B0601) of the core particles is less than 0.1 μm, then the anchoring effect on the resin coating layer that is subsequently coated onto the surface of the core particles weakens, meaning that when the particles are used as a developer, not only is the resin coating layer prone to separation from the core particles, but the specific gravity of the carrier particles also increases, making it impossible to achieve the targeted reduction in specific gravity, and preventing the manifestation of the desired reduction in collision energy.

In addition, the surface roughness Ra (compliant with JIS B0601) of the carrier that includes a resin coating layer formed on the surface of the core particles satisfies the expression Ra≦0.5 μm, and the sphericity of the carrier is 0.975 or higher. Furthermore, the core exposure ratio at the surface of the carrier is 2% or lower.

In this manner, by covering essentially the entire surface of the core particles with the resin coating layer, and minimizing the irregularities on the carrier surface, not only is the frictional energy able to be reduced, but the anchoring effect on the resin coating layer provided by the core particle is able to function more effectively, meaning separation of the resin coating layer can be suppressed. By employing the carrier shape described above, not only can charge be imparted more efficiently to the toner, but stress between carrier particles and stress inside the developing unit can be reduced.

If the surface roughness Ra (compliant with JIS B0601) of the carrier surface exceeds 0.5 μm, then the toner component becomes prone to scraping by the carrier surface, and accumulation and fusion of the toner component within recesses on the carrier may exacerbate the toner spent problem.

Furthermore, the sphericity of the carrier is 0.975 or higher, and the closer this value is to 1, the closer the carrier particles are to a true spherical shape, and furthermore, the larger the surface roughness value becomes, the more likely the existence of fine irregularities within the surface. By adjusting the sphericity of the carrier to 0.975 or higher, thereby bringing the shape closer to a true spherical shape, the fluidity of the carrier is improved, enabling a more uniform resin coating layer to be formed, and enabling suppression of aggregation of the core particles, thereby improving the production yield. As described above, the sphericity is measured using the LPF measurement mode of a FPIA-3000 device (manufactured by Sysmex Corporation).

Furthermore, the core exposure ratio at the surface of the carrier is 2% or lower. In cases such as the present invention, where core particles with surface irregularities are used, the exposed portions of the core that occur at the carrier surface are usually protrusions. In those cases where factors such as stress inside the developing unit cause the resin coating layer of the carrier to separate, the exposed core portions that exist at the carrier surface act as nuclei for this separation of the resin coating layer. If the core exposure ratio exceeds 2%, then the number of locations for potential separation of the resin coating layer increases, meaning the resin coating layer is more likely to undergo separation upon extended use. In other words, the charging function of the carrier deteriorates.

By ensuring that the core particles used in the present invention have fine irregularities at the particle surface, the resin coating layer can be firmly fixed to the particles by an anchoring effect, meaning separation of the coating layer from the carrier can be prevented. Furthermore, by ensuring that the surface of the core particles exhibits the surface roughness described above and includes protrusions, an electrical path can be formed via these protrusions in those cases where the toner density is high, meaning the resistance value of the developer is less likely to vary with variations in the toner density.

The magnetization C of the core particles of the present invention is measured within a magnetic field of 1 kOe, using a VSM (vibrating sample method) measuring apparatus and employing a BH tracer method, and the resulting magnetization value σ1000 is typically within a range from 45 to 90 Am²/kg (emu/g), and preferably from 45 to 70 Am²/kg (emu/g). If the value of σ1000 is less than 50 Am²/kg (emu/g), then the magnetic adsorption to the developing roller weakens, which can cause the particles to adhere to the photoreceptor, causing undesirable image defects. In contrast, if the value of σ1000 exceeds 90 Am²/kg (emu/g), then the magnetic brush becomes overly hard, which increases the likelihood of the particles rubbing overly strongly against the photoreceptor, generating undesirable scratches.

The average particle size of the core particles of the present invention is typically within a range from 10 to 100 μm, and is preferably from 20 to 50 μm. If the average particle size is smaller than 10 μm, then the developer is prone to flying off the developing unit, whereas if the average particle size exceeds 100 μm, achieving a satisfactory image density becomes impossible.

The electrical resistance of the carrier with the formed resin coating layer, when the measurement electric field is 5,000 V/cm, is typically within a range from 1×10⁵ to 1×10¹⁴ Ω-cm, and is preferably from 1×10⁹ to 1×10¹² Ω-cm.

The charge of the carrier with the formed resin coating layer is preferably within a range from 15 to 50 μC/g. If this carrier charge is less than 15 μC/g, then toner staining of non-image areas can occur (known as fogging), increasing the possibility that a high quality color image will be unobtainable, whereas if the carrier charge exceeds 50 μC/g, achieving a satisfactory image density may become problematic.

If the electrical resistance of the carrier with the formed resin coating layer is less than 1×10⁵ Ω-cm, then the charge is able to migrate more readily from the carrier surface, meaning image defects such as brush marks become more likely, and if the printer is left standing idle, with no print operation conducted for a certain period, then the charge may undergo an excessive decrease, causing scumming or the like on the first page that is printed on recommencement of printing. If the electrical resistance of the carrier with the formed resin coating layer exceeds 1×10¹⁴ Ω-cm, then not only is a favorable solid image unattainable, but if printing is conducted continuously for multiple copies, then the toner charge becomes excessively high, causing a reduction in the image density.

When measured in the form of a magnetic brush, the dynamic electrical resistance of the carrier under an electric field of 10⁴ V/cm is typically within a range from 1×10³ to 1×10¹³Ω-cm, and is preferably from 1×10⁵ to 1×10¹² Ω-cm. If the dynamic electrical resistance is less than 1×10³ Ω-cm, then the likelihood of image defects such as brush marks increases, whereas if the electrical resistance exceeds 1×10¹³ Ω-cm, then achieving a favorable solid image may become problematic. An electric field of 10³ V/cm is similar to the developing electric field within an actual apparatus, and this is the reason that the above dynamic electrical resistance is measured under a field of this strength.

From the above description it can be ascertained that the dynamic electrical resistance on mixing the carrier and the toner is preferably within a range from 1×10⁵ to 1×10¹³ Ω-cm under an electric field of 10³ V/cm. If this dynamic electrical resistance is less than 1×10⁵ Ω-cm, then various problems can arise, including scumming caused by a reduction in the toner charge when left standing following printing, or broadening of line images and a resulting deterioration in resolution caused by over-development. If the dynamic electrical resistance exceeds 1×10¹³Ω-cm, then a deterioration in the developing characteristics of the edges of solid images may make achieving a high quality image impossible.

The dynamic electrical resistance of the carrier is determined in the manner described below. Namely, approximately 30 cm³ of the carrier is deposited on the developing roller (the magnetic field on the surface of the developing roller sleeve generates 1 kOe) to form a magnetic brush, and a planar electrode with a surface area of 3 cm² is positioned facing the developing roller with a spacing of 2.5 mm therebetween. A voltage is then applied between the developing roller and the planar electrode while the developing roller is rotated at a rotational speed of 120 rpm, and the resulting current is measured. The thus obtained current-voltage relationship is then used to determine the dynamic electrical resistance using Ohm's law. It is well known that a relationship represented by the expression 1n(I/V)∝V×½ applies between the applied voltage V and the current I. In cases where the dynamic electrical resistance is very small, as is the case in the carrier used in the present invention, a high electric field of 10³ V/cm or greater may produce a very large current, making measurement impossible. In such cases, three or more measurements are conducted under lower electric fields, and a least squares method is then used to extrapolate the value to an electric field of 10⁴ V/cm using the relationship mentioned above.

Examples of the coating resin formed on top of the core particles include polyolefin-based resins such as polyethylene and polypropylene; polyvinyl-based and polyvinylidene-based resins such as polystyrene, acrylic resins, polyacrylonitrile, polyvinyl acetate, polyvinyl alcohol, polyvinyl butyral, polyvinyl chloride, polyvinyl carbazole, polyvinyl ether, and polyvinyl ketone; copolymers of vinyl chloride and vinyl acetate; copolymers of styrene and acrylic acid; straight silicon resins formed from organosiloxane linkages, or modified products thereof; fluororesins such as polytetrafluoroethylene, polyvinyl fluoride, polyvinylidene fluoride, and polychlorotrifluoroethylene; polyester; polyurethane; polycarbonate; amino resins such as urea-formaldehyde resin; and epoxy resins. These resins may be used either alone, or as a mixture of multiple resins.

The thickness of the resin coating layer is typically within a range from 0.1 to 5 μm, and preferably from 0.3 to 3 μm. If the thickness of the resin coating layer is less than 0.1 μm, then forming a uniform and smooth coating layer on the surface of the core particles becomes difficult. In contrast, if the thickness exceeds 5 μm, then aggregation of carrier particles tends to occur, making it difficult to obtain a uniform carrier.

Suitable methods of forming the resin coating layer on the core particles include immersion methods in which the core particles are immersed in a resin coating layer-forming solution, spray methods in which a resin coating layer-forming solution is sprayed onto the core particles, fluidized bed methods in which a resin coating layer-forming solution is atomized while the core particles are maintained in a floating state using an air flow, and kneader coater methods in which the core particles and a resin coating layer-forming solution are mixed together in a kneader coater and the solvent is subsequently removed.

There are no particular restrictions on the solvent used within the resin coating layer-forming solution, provided it is capable of dissolving the aforementioned coating resin, and suitable solvents include aromatic hydrocarbons such as toluene and xylene, ketones such as acetone and methyl ethyl ketone, and ethers such as tetrahydrofuran and dioxane. Furthermore, suitable methods of dispersing the conductive powder include methods using a sand mill, dyno mill or homomixer.

### [Electrostatic Latent Image Developer]

An electrostatic latent image developer used in the present invention is a two-component developer that contains a toner and a carrier. The toner described below may be either a magnetic toner or a non-magnetic toner. Below, the term “electrostatic latent image developer” may be abbreviated as simply “developer”.

In the present invention, the toner can be prepared using a so-called aggregation fusion method that includes: a first step of heating a dispersion containing at least dispersed resin particles at a temperature no higher than the glass transition temperature of the resin particles, thereby forming aggregate particles and producing an aggregate particle dispersion, a second step of adding and mixing a fine particle dispersion containing dispersed fine particles with the aggregate particle dispersion, thereby causing the fine particles to adhere to the aggregate particles and generate adhered particles, and a third step of heating and fusing the adhered particles.

The characteristics of such a toner include a comparatively round particle shape, a narrow particle size distribution, a comparatively uniform toner surface with high chargeability, and a favorably narrow charge distribution.

Accordingly, an electrostatic latent image developer obtained by mixing the toner with the aforementioned carrier exhibits extremely good fluidity and developing properties, meaning a developer is obtained that is ideal as a high quality color developer.

Examples of other toners that can be used include polymer toners, solution-suspension toners, emulsification-aggregation toners, and kneading/grinding/classification/spheronization type toners.

The following description focuses on the case in which an emulsification-aggregation toner is used in the developer.

In an exemplary embodiment of the present invention, aggregation and fusion are conducted using fine resin particles and fine particles of a yellow, magenta, cyan or black pigment respectively, thus yielding a series of colored toners. Furthermore, the volume average particle size for each toner is within a range from approximately 3 to 9 μm, and the average value of the shape factor SF1 is at least 100 but no higher than 135. The shape factor SF1 can be calculated from the formula shown below.

SF1=(ML²/A)×(π/4)×100

In this formula, ML represents the average value of the absolute maximum length of the particles, and A represents the projected area of particles, and these values are converted to numerical form mainly by analyzing a microscope image or a scanning electron microscope image using an image analyzer.

As disclosed in Japanese Patent Laid-Open Publication No. Hei10-026842, Japanese Patent Laid-Open Publication No. Hei 10-133423, Japanese Patent Laid-Open Publication No. Hei 10-198070 and Japanese Patent Laid-Open Publication No. Hei 11-231570, these toners can be prepared by a method of producing toner for an electrostatic latent image developer that includes: a first step of heating a dispersion containing at least dispersed resin particles at a temperature no higher than the glass transition temperature of the resin particles, thereby forming aggregate particles and producing an aggregate particle dispersion, a second step of adding and mixing a fine particle dispersion containing dispersed fine particles with the aggregate particle dispersion, thereby causing the fine particles to adhere to the aggregate particles and generate adhered particles, and a third step of heating and fusing the adhered particles.

The volume average particle size, particle shape and particle size distribution can be adjusted by adjusting factors such as the conditions during preparation of the aggregate particle dispersion, the conditions during formation of the adhered particles, and the conditions during heating and fusion of the adhered particles.

The dispersion described above is prepared by dispersing at least resin particles. These resin particles are particles formed from a resin. Examples of this resin include the various thermoplastic binder resins, and specific examples include homopolymers or copolymers of styrenes such as styrene, para-chlorostyrene and α-methylstyrene (namely, styrene-based resins); homopolymers or copolymers of esters having a vinyl group such as methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate and 2-ethylhexyl methacrylate (namely, vinyl-based resins); homopolymers or copolymers of vinyl nitriles such as acrylonitrile and methacrylonitrile (vinyl-based resins); homopolymers or copolymers of vinyl ethers such as vinyl methyl ether and vinyl isobutyl ether (vinyl-based resins); homopolymers or copolymers of vinyl ketones such as vinyl methyl ketone, vinyl ethyl ketone and vinyl isopropenyl ketone, (vinyl-based resins); homopolymers or copolymers of olefins such as ethylene, propylene, butadiene and isoprene (namely, olefin-based resins); non-vinyl condensation resins such as epoxy resins, polyester resins, polyurethane resins, polyamide resins, cellulose resins and polyether resins, and graft polymers of these non-vinyl condensation resins and vinyl-based monomers. These resins may be used either alone, or in combinations of two or more different resins.

Of these resins, styrene-based reins, vinyl-based resins, polyester resins and olefin-based resins are preferred, and copolymers of styrene and n-butylacrylate, poly(n-butylacrylate), copolymers of bisphenol A and fumaric acid, and copolymers of styrene and an olefin are particularly desirable.

The average particle size of the resin particles is typically no greater than 1 μm, and is preferably within a range from 0.01 to 1 μm. If this average particle size exceeds 1 μm, then the particle size distribution of the final product electrostatic latent image toner broadens, which leads to the generation of free particles, and tends to result in a deterioration in the performance and reliability of the toner. In contrast, if the average particle size falls within the above range, then not only can the above drawbacks be avoided, but other advantages are also realized, including a reduction in uneven distribution within the toner, more favorable dispersion within the toner, and less variation in the performance and reliability of the toner. The average particle size can be measured, for example, using a laser diffraction method (LA-700, manufactured by Horiba, Ltd.).

Examples of suitable colorants include pigments such as carbon black, chrome yellow, hansa yellow, benzidine yellow, threne yellow, quinoline yellow, permanent orange GTR, pyrazolone orange, vulkan orange, watchung red, permanent red, brilliant carmine 3B, brilliant carmine 6B, Dupont oil red, pyrazolone red, lithol red, rhodamine B lake, lake red C, rose bengal, aniline blue, ultramarine blue, calco oil blue, methylene blue chloride, phthalocyanine blue, phthalocyanine green and malachite green oxalate; and dyes such as acridine-based dyes, xanthene-based dyes, azo-based dyes, benzoquinone-based dyes, azine-based dyes, anthraquinone-based dyes, dioxazine-based dyes, thiazine-based dyes, azomethine-based dyes, indigo-based dyes, thioindigo-based dyes, phthalocyanine-based dyes, aniline black-based dyes, polymethine-based dyes, triphenylmethane-based dyes, diphenylmethane-based dyes and thiazole-based dyes. These colorants may be used either alone, or in combinations of two or more different colorants.

The average particle size of the colorant is typically no greater than 1 μm, and is preferably within a range from 0.01 to 1 μm. If this average particle size exceeds 1 μm, then the particle size distribution of the final product electrostatic latent image toner broadens, which leads to the generation of free particles, and tends to result in a deterioration in the performance and reliability of the toner. In contrast, if the average particle size falls within the above range, then not only can the above drawbacks be avoided, but other advantages are also realized, including a reduction in uneven distribution within the toner, more favorable dispersion within the toner, and less variation in the performance and reliability of the toner. The average particle size can be measured, for example, using a laser diffraction method (LA-700, manufactured by Horiba, Ltd.).

Depending on the purpose of the present invention, other components may also be dispersed within the aforementioned dispersion, including release agents, internal additives, charge control agents, inorganic particles, lubricants and abrasives. In such cases, these other particles may simply be dispersed in the dispersion containing the dispersed resin particles, or a separate dispersion formed by dispersing the other particles may be mixed with the dispersion containing the dispersed resin particles.

Examples of suitable release agents include low molecular weight polyolefins such as polyethylene, polypropylene and polybutene; silicones that exhibit a softening point under heating; fatty acid amides such as oleyl amide, erucyl amide, ricinoleyl amide and stearyl amide; vegetable waxes such as carnauba wax, rice wax, candelilla wax, Japan wax and jojoba oil; animal waxes such as beeswax; mineral or petroleum waxes such as montan wax, ozokerite, ceresin, paraffin wax, microcrystalline wax and Fischer-Tropsch wax; as well as modified products of the above.

These waxes can easily be converted to fine particles of no more than 1 μm by dispersing the wax in water together with an ionic surfactant and a polymer electrolyte such as a polymeric acid or polymeric base, heating the dispersion to a temperature at least as high as the melting point of the wax, and then processing the dispersion using a homogenizer or pressure discharge disperser capable of imparting a powerful shearing force.

Examples of the aforementioned charge control agents include quaternary ammonium salts, nigrosine-based compounds, dyes formed from complexes of aluminum, iron or chromium, and triphenylmethane-based pigments. In the present invention, from the viewpoints of enabling more favorable control of the ionic strength, which effects the level of safety during aggregation and fusion, and reducing wastewater contamination, the charge control agent is preferably a material that is substantially insoluble in water.

Examples of the aforementioned inorganic particles include those particles that are typically used as external additives for the toner surface, such as silica, alumina, titania, calcium carbonate, magnesium carbonate, calcium phosphate and cerium oxide. Examples of the aforementioned lubricants include fatty acid amides such as ethylene bis stearamide and oleyl amide, and fatty acid metal salts such as zinc stearate and calcium stearate. Examples of the aforementioned abrasives include the previously mentioned silica, alumina and cerium oxide.

In a method of producing the toner, the resin fine particle dispersion and colorant dispersion and the like described above are mixed together to prepare a uniform mixed particle dispersion, and an inorganic metal salt that is soluble in the dispersion medium is then added and mixed, thereby forming the desired aggregate particles. During this process, the resin fine particles, the colorant, and any inorganic fine particles that are added as necessary may either be added in a single batch, or may be divided into portions so that the fine particles are added in stages, thereby enabling the aggregate particles to be imparted with a core shell structure, or a structure in which the component concentration varies across the radial direction of the particles. In such cases, the resin fine particle dispersion, the colorant particle dispersion, and the release agent fine particle dispersion and the like are mixed together and dispersed, and the aggregate particles are grown until a certain particle size is achieved. If required, an additional resin fine particle dispersion or the like may then be added in order to adhere these additional resin fine particles to the surface of the aggregate particles. By coating the surface of the aggregate particles, the additional resin fine particles can prevent the exposure of the colorant or the release agent at the toner surface, thereby effectively suppressing charge irregularities or non-uniform charging caused by such exposure.

In the above aggregation step of forming the aggregate particles, a bivalent or higher inorganic metal salt is used as a coagulant, and a trivalent or higher salt, and particularly a tetravalent salt, is preferred. The cohesive force of the inorganic metal salt increases with increasing valency, enabling the aggregation process to be controlled with favorable stability, and as a result, an excellent particle size distribution with minimal non-aggregated material can be obtained. Examples of suitable tetravalent or higher inorganic metal salt polymers that can be used include polyaluminum chloride and polyaluminum hydroxide.

Following preparation of aggregate particles of the desired particle size in this manner, the target toner particles can be obtained by fusing the aggregate particles by heating at a temperature at least as high as the glass transition temperature of the resin. By appropriate selection of the fusion heating conditions, the toner shape can be controlled to yield amorphous through to spherical particles. By conducting fusion at a high temperature over an extended period, the shape of the toner particles moves closer to a true spherical shape.

The average particle size of the toner is typically no higher than 10 μm, and is preferably within a range from 3 to 9 μm.

When a developer is prepared by mixing together a toner and a carrier, the proportion of the toner is typically within a range from 1 to 15% by weight, and preferably from 3 to 12% by weight of the entire developer.

If the proportion of toner is less than 1% by weight, then achieving a satisfactory image density may become difficult, and achieving uniform solid printing may also be difficult. In contrast, if the proportion of toner exceeds 15% by weight, then because the toner coating ratio on the carrier surface exceeds 100%, the charge quantity falls (with the absolute value of the average charge quantity falling to less than 15 μC/g), and toner staining (fogging) occurs within non-image areas, making it more difficult to achieve a high quality color image. For example, if the toner proportion exceeds 15% by weight, then because the toner coating ratio on the carrier surface approaches 100%, the resistance of the developer increases dramatically and becomes difficult to maintain within the range from 1×10⁵ to 1×10⁸ Ω.cm, which increases the likelihood of blurring at the image edges, and makes obtaining a favorable high quality color image more difficult.

In a low humidity environment, if the toner proportion is less than 1% by weight, then the developer is prone to developing a very high charge (with the absolute value of the average charge quantity exceeding 25 μC/g), which may make it impossible to achieve a satisfactory image density. Accordingly, depending on the environment, the proportion of toner is preferably selected so that the absolute value of the charge quantity falls within a range from 15 to 50 μC/g.

### [Image Forming Method]

As follows is a description of an image forming method according to an exemplary embodiment of the present invention.

An image forming method of the present invention includes: forming an electrostatic latent image on the surface of a latent image holding member; developing the electrostatic latent image formed on the surface of the latent image holding member using a developer supported on a developer carrier, thereby forming a toner image; transferring the toner image formed on the surface of the latent image holding member to the surface of a transfer target; and heat fixing the toner image that has been transferred to the surface of the transfer target, wherein the developer contains at least an electrophotographic carrier according to the present invention.

Each of the above steps can use conventional processes from known image forming methods.

An electrophotographic photoreceptor or a dielectric recording material may be used as the latent image holding member. In the case of an electrophotographic photoreceptor, the surface of the electrophotographic photoreceptor is charged uniformly using a corotron charger or a contact charger or the like, and is then exposed to form an electrostatic latent image (the latent image-forming step). Subsequently, toner particles are adhered to the electrostatic latent image by bringing the image either into contact with, or into close proximity to, a developing roller with a developer layer formed on the surface thereof, thereby forming a toner image on the electrophotographic photoreceptor (the developing step). The thus formed toner image is then transferred to the surface of a transfer target material such as a sheet of paper using a corotron charger or the like (the transfer step). The toner image that has been transferred to the surface of the transfer target is subsequently subjected to heat fixing using a fixing device, thereby forming the final toner image.

During heat fixing by the above fixing device, a release agent is usually supplied to the fixing member of the above fixing device in order to prevent offset problems and the like.

In order to achieve favorable releasability at the surface of the roller or belt that functions as the fixing member within the fixing device, the use of a material that exhibits a low surface energy is desirable. Furthermore, there are no particular restrictions on the method used for supplying the release agent, and suitable methods include a pad system that uses a pad impregnated with the liquid release agent, a web system, a roller system, and a non-contact shower system (a spray system), although of these, a web system or roller system is preferred. These systems offer the advantages that the release agent can be supplied uniformly, and the quantity of release agent supplied can be readily controlled. If a shower system is used, then a separate blade or the like should be used to ensure that the release agent is supplied uniformly across the entire fixing member.

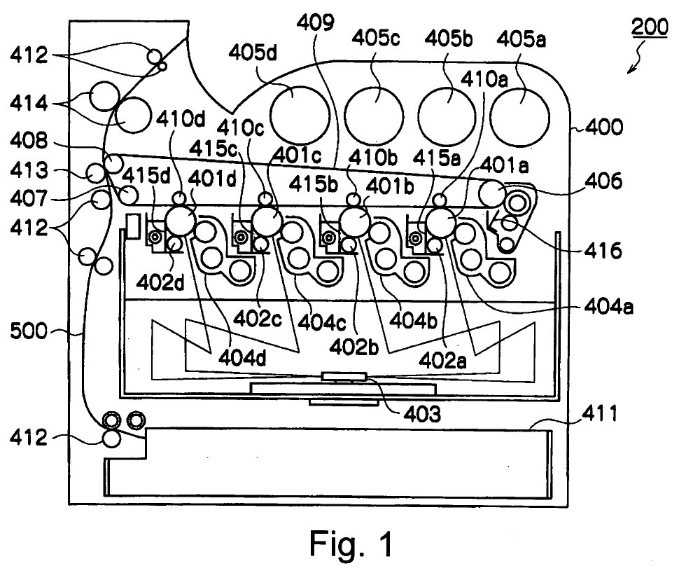

FIG. 1 is a schematic illustration showing a sample configuration of an image forming apparatus that forms an image using an image forming method according to the present invention. The image forming apparatus 200 shown in the drawing includes four electrophotographic photoreceptors 401a to 401d positioned in a mutually parallel arrangement along an intermediate transfer belt 409 inside a housing 400. These electrophotographic photoreceptors 401a to 401d are configured so that, for example, the electrophotographic photoreceptor 401a is capable of forming a yellow image, the electrophotographic photoreceptor 401b is capable of forming a magenta image, the electrophotographic photoreceptor 401c is capable of forming a cyan image, and the electrophotographic photoreceptor 401d is capable of forming a black image.

The electrophotographic photoreceptors 401a to 401d are each capable of rotating in a predetermined direction (in a counterclockwise direction within the plane of the drawing), and around this rotational direction there are provided charging rollers 402a to 402d, developing units 404a to 404d, primary transfer rollers 410a to 410d, and cleaning blades 415a to 415d. The four colored toners, namely the black, yellow, magenta and cyan toners housed within the toner cartridges 405a to 405d can be supplied to the developing units 404a to 404d respectively. Furthermore, the primary transfer rollers 410a to 410d contact the electrophotographic photoreceptors 401a to 401d respectively across the intermediate transfer belt 409.

An exposure unit 403 is also positioned at a predetermined location inside the housing 400, and the light beam emitted from the exposure unit 403 is able to be irradiated onto the surfaces of the charged electrophotographic photoreceptors 401a to 401d. Accordingly, rotating the electrophotographic photoreceptors 401a to 401d enables the processes of charging, exposure, developing, primary transfer and cleaning to be conducted in sequence, thereby transferring and superimposing the toner image for each color onto the intermediate transfer belt 409.

In this description, the charging rollers 402a to 402d are used for bringing a conductive member (the charging roller) into contact with the surface of the respective electrophotographic photoreceptor 401a to 401d, thereby applying a uniform voltage to the photoreceptor and charging the photoreceptor surface to a predetermined potential (the charging step). Besides the charging rollers shown in this exemplary embodiment, charging may also be conducted using contact charging systems that employ charging brushes, charging films or charging tubes. Furthermore, charging may also be conducted using non-contact systems that employ a corotron or a scorotron.

The exposure unit 403 may employ an optical device that enables a light source such as a semiconductor laser, an LED (light emitting diode) or a liquid crystal shutter to be irradiated onto the surface of the electrophotographic photoreceptors 401a to 401d with a desired image pattern. Of these possibilities, if an exposure unit that is capable of irradiating incoherent light is used, then the generation of interference patterns between the conductive base material and the photosensitive layer of the electrophotographic photoreceptors 401a to 401d can be prevented.

For the developing units 404a to 404d, typical developing units that use the aforementioned two-component electrostatic latent image developer to conduct developing via either a contact or non-contact process may be used (the developing step). There are no particular restrictions on these types of developing units, provided they use a two-component electrostatic latent image developer, and appropriate conventional units may be selected in accordance with the desired purpose.

In the primary transfer step, a primary transfer bias of the reverse polarity to the toner supported on the image holding member is applied to the primary transfer rollers 410a to 410d, thereby effecting sequential primary transfer of each of the colored toners to the intermediate transfer belt 409.

The cleaning blades 415 to 415d are used for removing residual toner adhered to the surfaces of the electrophotographic photoreceptors following the transfer step, and the resulting surface-cleaned electrophotographic photoreceptors are then reused within the above image forming process. Suitable materials for the cleaning blades include urethane rubbers, neoprene rubbers and silicone rubbers.

The intermediate transfer belt 409 is supported at a predetermined level of tension by a drive roller 406, a backup roller 408 and a tension roller 407, and can be rotated without slack by rotation of these rollers. Furthermore, a secondary transfer roller 413 is positioned so as to contact the backup roller 408 across the intermediate transfer belt 409.

By applying a secondary transfer bias of the reverse polarity to the toner on the intermediate transfer belt to the secondary transfer roller 413, the toner undergoes secondary transfer from the intermediate transfer belt to the recording medium. After passing between the backup-roller 408 and the secondary transfer roller 413, the intermediate transfer belt 409 is surface-cleaned by either a cleaning blade 416 positioned near the driver roller 406 or a charge neutralizing device (not shown in the drawing), and is then reused in the next image forming process. Furthermore, a tray (a transfer target medium tray) 411 is provided at a predetermined position within the housing 400, and a transfer target medium 500 such as paper stored within this tray 411 is fed by feed rollers 412 between the intermediate transfer belt 409 and the secondary transfer roller 413, and then between two mutually contacting fixing rollers 414, before being discharged from the housing 400.

### EXAMPLES

As follows is a description of specifics of the present invention based on a series of examples and comparative examples.

### [Production of Core Particles A]

MnO, MgO and Fe₂O₃ are mixed together thoroughly in quantities of 29 parts by weight, 1 part by weight and 70 parts by weight respectively, and this raw material mixture is mixed and ground for 10 hours in a wet ball mill, and then finely ground and dispersed using a rotary kiln. The mixture is then subjected to preliminary baking at 900° C. for 1 hour in the rotary kiln. The resulting prebaked product is then ground for a further 10 hours in a wet ball mill, yielding an oxide slurry with an average particle size of 0.8 μm. To the thus obtained slurry is added suitable quantities of a dispersant and polyvinyl alcohol (0.3% by weight relative to 100% by weight of the oxide slurry), and following granulation and drying using a spray dryer, full baking is conducted in a rotary electric kiln, by holding the product under conditions including a temperature of 1100° C. and an oxygen concentration of 0.3% for a period of 7 hours. The resulting ferrite particles are subjected to magnetic concentration, and are then mixed to yield core particles A. The core particles A have an Sm value of 1.06 μm and an Ra value of 0.39 μm.

### [Production of Core Particles B]

Li₂O, MgO, CaO and Fe₂O₃ are mixed together thoroughly in quantities of 15 parts by weight, 7 parts by weight, 3 parts by weight and 75 parts by weight respectively, and this raw material mixture is mixed and ground for 10 hours in a wet ball mill, and then finely ground and dispersed using a rotary kiln. The mixture is then subjected to preliminary baking at 900° C. for 1 hour in the rotary kiln. The resulting prebaked product is then ground for a further 10 hours in a wet ball mill, yielding an oxide slurry with an average particle size of 0.8 μm. To the thus obtained slurry is added suitable quantities of a dispersant and polyvinyl alcohol (0.3% by weight relative to 100% by weight of the oxide slurry), and following granulation and drying using a spray dryer, full baking is conducted in a rotary electric kiln, by holding the product under conditions including a temperature of 1100° C. and an oxygen concentration of 0.3% for a period of 7 hours. The resulting ferrite particles are subjected to magnetic concentration, and are then mixed to yield core particles B. The core particles B have an Sm value of 1.52 μm and an Ra value of 0.62 μm.

### [Production of Core Particles C]

MnO, MgO and Fe₂O₃ are mixed together thoroughly in quantities of 29 parts by weight, 1 part by weight and 70 parts by weight respectively, and this raw material mixture is mixed and ground for 10 hours in a wet ball mill, and then finely ground and dispersed using a rotary kiln. The mixture is then subjected to preliminary baking at 900° C. for 1 hour in the rotary kiln. The resulting prebaked product is then ground for a further 8 hours in a wet ball mill, yielding an oxide slurry with an average particle size of 1.8 μm. To the thus obtained slurry is added suitable quantities of a dispersant and polyvinyl alcohol (0.3% by weight relative to 100% by weight of the oxide slurry), and following granulation and drying using a spray dryer, full baking is conducted in a rotary electric kiln, by holding the product under conditions including a temperature of 1100° C. and an oxygen concentration of 0.3% for a period of 7 hours. The resulting ferrite particles are subjected to magnetic concentration, and are then mixed to yield core particles C. The core particles C have an Sm value of 1.91 μm and an Ra value of 0.85 μm.

### [Production of Core Particles D]

MnO, MgO and Fe₂O₃ are mixed together thoroughly in quantities of 29 parts by weight, 1 part by weight and 70 parts by weight respectively, and this raw material mixture is mixed and ground for 10 hours in a wet ball mill, and then finely ground and dispersed using a rotary kiln. The mixture is then subjected to preliminary baking at 900° C. for 1 hour in the rotary kiln. The resulting prebaked product is then ground for a further 10 hours in a wet ball mill, yielding an oxide slurry with an average particle size of 0.8 μm. To the thus obtained slurry is added suitable quantities of a dispersant and polyvinyl alcohol (0.3% by weight relative to 100% by weight of the oxide slurry), and following granulation and drying using a spray dryer, full baking is conducted in a rotary electric kiln, by holding the product under conditions including a temperature of 1300° C. and an oxygen concentration of 0.3% for a period of 7 hours. The resulting ferrite particles are subjected to magnetic concentration, and are then mixed to yield core particles D. The core particles D have an Sm value of 0.84 μm and an Ra value of 4.39 μm.

### [Production of Carrier A]

A resin coating layer-forming raw material solution A containing the components listed below is stirred and dispersed for 60 minutes with a stirrer, thus forming a resin coating layer-forming raw material solution A. Subsequently, this resin coating layer-forming raw material solution A and 100 parts by weight of the core particles A are placed inside a vacuum deaeration kneader, and following stirring for 30 minutes at 70° C., the pressure is reduced and the mixture is deaerated and dried. The resulting product is then passed through a 75 μm mesh, yielding a carrier A. The thus obtained carrier A has an Ra value of 0.22 and a sphericity of 0.993, and the core exposure ratio at the surface of the carrier A is 2%.

<Resin coating layer-forming raw material solution A>

| | |
|---|---|
| Toluene: | 18 parts by weight |
| Styrene-methacrylate copolymer (component ratio | 4.5 parts by weight |
| 30:70) | |
| Carbon black (Regal 330, manufactured by Cabot | 0.7 parts by weight |
| Corporation) | |

### [Production of Carrier B]

A resin coating layer-forming raw material solution B containing the components listed below is stirred and dispersed for 60 minutes with a stirrer, thus forming a resin coating layer-forming raw material solution B, this resin coating layer-forming raw material solution B and 100 parts by weight of the core particles B are then stirred together for 30 minutes, and the pressure is subsequently reduced and the mixture is deaerated and dried. The resulting product is then passed through a 75 μm mesh, yielding a carrier B. The thus obtained carrier B has an Ra value of 0.45 and a sphericity of 0.982, and the core exposure ratio at the surface of the carrier B is 2%.

<Resin coating layer-forming raw material solution B>

| | |
|---|---|
| Methanol: | 20 parts by weight |
| γ-aminotriethoxysilane (KBE903, manufactured | 2.2 parts by weight |
| by Shin-Etsu Chemical Co., Ltd.) | |
| Carbon black (Regal 330, manufactured by Cabot | 0.34 parts by weight |
| Corporation) | |

### [Production of Carrier C]

A resin coating layer-forming raw material solution C containing the components listed below is stirred and dispersed for 60 minutes with a stirrer, thus forming a resin coating layer-forming raw material solution C. Subsequently, this resin coating layer-forming raw material solution C and 100 parts by weight of the core particles A are placed inside a vacuum deaeration kneader, and following stirring for 30 minutes at 70° C., the pressure is reduced and the mixture is deaerated and dried. The resulting product is then passed through a 75 μm mesh, yielding a carrier C. The thus obtained carrier C has an Ra value of 0.31 and a sphericity of 0.972, and the core exposure ratio at the surface of the carrier C is 4.3%.

<Resin coating layer-forming raw material solution C>

| | |
|---|---|
| Toluene: | 8.6 parts by weight |
| Styrene-methacrylate copolymer (component | 1.30 parts by weight |
| ratio 30:70) | |
| Carbon black (Regal 330, manufactured by Cabot | 0.20 parts by weight |
| Corporation) | |

### [Production of Carrier D]

A resin coating layer-forming raw material solution A containing the components listed above is stirred and dispersed for 60 minutes with a stirrer, thus forming a resin coating layer-forming raw material solution A. Subsequently, this resin coating layer-forming raw material solution A and 100 parts by weight of the core particles C are placed inside a vacuum deaeration kneader, and following stirring for 30 minutes at 70° C., the pressure is reduced and the mixture is deaerated and dried. The resulting product is then passed through a 75 μm mesh, yielding a carrier D. The thus obtained carrier D has an Ra value of 0.65 and a sphericity of 0.991, and the core exposure ratio at the surface of the carrier A is 3.6%.

### [Production of Carrier E]

A resin coating layer-forming raw material solution B containing the components listed above is stirred and dispersed for 60 minutes with a stirrer, thus forming a resin coating layer-forming raw material solution B. Subsequently, this resin coating layer-forming raw material solution B and 100 parts by weight of the core particles D are placed inside a vacuum deaeration kneader, and following stirring for 30 minutes at 70° C., the pressure is reduced and the mixture is deaerated and dried. The resulting product is then passed through a 75 μm mesh, yielding a carrier E. The thus obtained carrier E has an Ra value of 0.72 and a sphericity of 0.973, and the core exposure ratio at the surface of the carrier E is 5%.

### [Production of Toner A]

A detailed description of one example of preparing a toner of the present invention is presented below, although the present invention is in no way restricted by the following example.

<Preparation of Resin Fine Particle Dispersion>

| | | |
|---|---|---|
| Styrene | 296 | parts by weight |
| n-butyl acrylate | 104 | parts by weight |
| Acrylic acid | 6 | parts by weight |
| Dodecanethiol | 10 | parts by weight |
| Divinyl adipate | 1.6 | parts by weight |

### (All these components are manufactured by Wako Pure Chemical Industries, Ltd.)

A mixture prepared by mixing and dissolving the above components is added to a solution containing 12 parts by weight of a non-ionic surfactant (Nonipol 400, manufactured by Sanyo Chemical Industries, Ltd.) and 8 parts by weight of an anionic surfactant (Neogen SC, manufactured by Dai-ichi Kogyo Seiyaku Co., Ltd.) dissolved in 610 parts by weight of ion-exchanged water, and following dispersion and emulsification within the flask, 50 parts by weight of ion-exchanged water containing 8 parts by weight of ammonium persulfate (manufactured by Wako Pure Chemical Industries, Ltd.) dissolved therein is added gradually while the mixture in the flask is stirred slowly for 10 minutes, and the flask is then flushed with nitrogen for 20 minutes at a rate of 0.1 liters/minute. Subsequently, the flask is placed in an oil bath and the internal temperature of the system is heated to 70° C. with constant stirring, and the emulsion polymerization is then allowed to progress at this temperature for 5 hours, yielding a resin fine particle dispersion with an average particle size of 200 nm and a solid fraction concentration of 40%. A sample prepared by placing a portion of this dispersion in an oven at 100° C. to remove the moisture is measured using a DSC (differential scanning calorimeter), and reveals a glass transition temperature of 53° C. and a weight average molecular weight of 32,000.

<Preparation of Colorant Dispersion (K)>

| | |
|---|---|
| Carbon black (Regal 330, manufactured by Cabot | 100 parts by weight |
| Corporation) | |
| Anionic surfactant (Neogen RK, manufactured by | 10 parts by weight |
| Dai-ichi Kogyo Seiyaku Co., Ltd.) | |
| Ion-exchanged water | 490 parts by weight |

The above components are mixed together and dissolved, and then dispersed for 10 minutes using a homogenizer (Ultraturrax, manufactured by IKA Works Inc.), thereby yielding a colorant dispersion (K).

<Preparation of Release Agent Particle Dispersion>

| | |
|---|---|
| Paraffin wax (HNP-9, manufactured by Nippon | 100 parts by weight |
| Seiro Co., Ltd.) | |
| Anionic surfactant (Lipal 860K, manufactured by | 10 parts by weight |
| Lion Corporation) | |
| Ion-exchanged water | 390 parts by weight |

The above components are mixed together and dissolved, dispersed using a homogenizer (Ultraturrax, manufactured by IKA Works Inc.), and then subjected to further dispersion treatment using a pressure discharge homogenizer, thereby yielding a release agent particle dispersion containing dispersed particles of a release agent (paraffin wax) with a center diameter of 220 nm.

(Production of Black Toner)

| | | |
|---|---|---|
| Resin fine particle dispersion | 320 | parts by weight |
| Colorant dispersion (K) | 80 | parts by weight |
| Release agent particle dispersion | 96 | parts by weight |
| Aluminum sulfate (manufactured by Wako Pure | 1.5 | parts by weight |
| Chemical Industries, Ltd.) | | |
| Ion-exchanged water | 1270 | parts by weight |

The above components are combined in a round-bottom stainless steel flask fitted with a temperature-regulating jacket, subsequently dispersed for 5 minutes at 5,000 rpm using a homogenizer (Ultraturrax T50, manufactured by IKA Works Inc.), and then transferred to another flask and stirred for 20 minutes at 25° C. using a 4-blade paddle. Subsequently, with the flask contents undergoing constant stirring, the flask is heated with a mantle heater at a rate of temperature increase of 1° C./minute until the contents reach a temperature of 48° C., and this temperature of 48° C. is maintained for 20 minutes. An additional 80 parts by weight of the resin particle dispersion is then added gently, and after holding the resulting mixture at 48° C. for a further 30 minutes, a 1N aqueous solution of sodium hydroxide is added to adjust the pH to 6.5.

Subsequently, the temperature is raised to 95° C. at a rate of 1° C./minute and then held at that temperature for 30 minutes. The pH of the system is then adjusted to 4.8 by adding a 0.1N aqueous solution of nitric acid, and the resulting mixture is then allowed to stand at 95° C. for a period of two hours. The aforementioned 1N aqueous solution of sodium hydroxide is then once again added to adjust the pH to 6.5, and the system is then allowed to stand for a further 5 hours at 95° C. The temperature is then cooled to 30° C. at a rate of 5° C./minute.

The resulting toner particle dispersion is filtered, and then (A) 2,000 parts by weight of 35° C. ion-exchanged water is added to the resulting toner particles, (B) the mixture is stirred for 20 minutes, and then (C) the mixture is filtered. The operations from (A) to (C) are repeated 5 times, and the toner particles on the filter are then transferred to a vacuum dryer, and dried for 10 hours at 45° C. under a pressure of no more than 1,000 Pa. The reason that a pressure of no more than 1,000 Pa is specified is that the toner particles contain moisture, which may be frozen in the initial stages of drying, even at 45° C., and because this moisture then undergoes sublimation during the drying process, the internal pressure within the reduced pressure dryer does not remain constant. However, at the completion of the drying process, this pressure stabilizes at 100 Pa. After returning the inside of the dryer to normal pressure, the resulting toner matrix particles are removed, 1.5 parts of a silica external additive (RY-50, manufactured by Nippon Aerosil Co., Ltd.) is added to 100 parts of the toner matrix particles, and the resulting mixture is blended for 3 minutes at 3,000 rpm in a Henschel mixer, thereby yielding a black toner.

The thus obtained black toner has a D50v value of 5.7 μm, a GSDp value of 1.23, an acid value of 28 mgKOH/g, and a glass transition temperature of 53° C.

### [Production of Toner B]

Using 87 parts of a binder resin (a bisphenol A polyester), 8 parts of carbon black (BPL, manufactured by Cabot Corporation), 1 part of a charge control agent (TRH, manufactured by Hodogaya Chemical Co., Ltd.), and 4 parts of polypropylene wax (660P, manufactured by Sanyo Chemical Industries, Ltd.), toner particles with an average particle size of 7.5 μm are prepared using a kneading-grinding method. To 100 parts of these toner particles is then added 1 part of a colloidal silica (R972, manufactured by Nippon Aerosil Co., Ltd.), and the resulting mixture is blended in a Henschel mixer, yielding a toner B.

### [Developer]

100 parts by weight samples of the aforementioned carriers A to E are blended with 8.5 parts by weight of one of the aforementioned toners A and B, thereby producing developers of the examples 1 to 3 and the comparative examples 1 to 3, as shown in Table 1.

### <Evaluation Methods>

### [Surface Roughness of Core Material and Carrier]

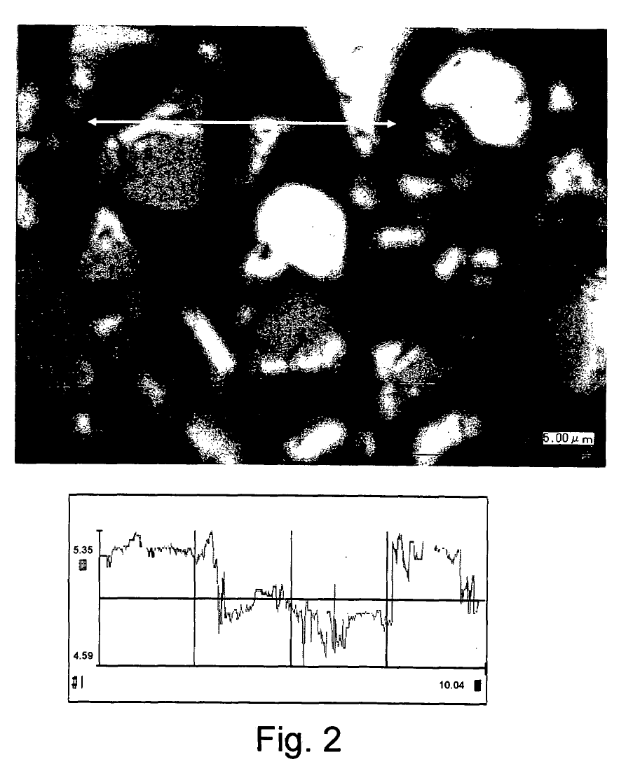

Using a laser microscope (VK-9500, an ultra-deep color 3D profile measuring microscope, manufactured by Keyence Corporation), the Sm and Ra values are measured for a particle surface area of 12×12 μm, and in each case, the average of 50 measured values is reported as the numerical value. FIG. 2 is an example of a photograph from the above laser microscope showing the surfaces of core particles and carrier particles, and the values of Sm and Ra are determined from a curve showing the relationship between measurement locations on the photograph and the corresponding surface roughness.

### [Carrier Sphericity]

The various characteristic values are measured using the LPF measurement mode of a FPIA-3000 device (manufactured by Sysmex Corporation). A sample is prepared by adding and mixing 200 mg of the carrier particles with 30 ml of an aqueous solution of ethylene glycol, removing the supernatant aqueous solution, and using the residue as the measurement sample. The average sphericity is determined by analyzing particles other than those with a particle size of either less than 10 μm or greater than 50 μm.

### [Core Exposure at Carrier Surface]

Using an X-ray photoelectron spectrophotometer (JPS-9000MX) manufactured by Jasco Corporation, measurement is conducted using a MgKα X-ray source, an output of 10 kV, and an analysis area of 10×10 mm. The peak intensities for each measured element are used to determine the respective atom concentration levels at the particle surface. Calculation of the surface atom concentration levels is conducted using the relative photosensitive factors provided by Jasco Corporation. The peak intensity of each of the measured elements is proportional to the quantity of atoms of that element that exist within the analysis area. In the present invention, an approximation of the amount of core exposure at the carrier surface is calculated by determining the ratio between the intensity of the peak derived from iron atoms at the carrier surface, and the intensity of the peak derived from iron atoms at the surface of the core particles.

Furthermore, in order to measure the amount of core exposure at the carrier surface within a developer, the developer is placed in a container such as a beaker, a suitable quantity of a surfactant solution (such as a 0.2% by weight aqueous solution of polyoxyethylene octylphenyl ether) is added, the carrier is held within the bottom of the container by holding a magnet beneath the container, and the toner alone is washed away. This operation is continued until the supernatant liquid becomes colorless and transparent. A suitable quantity of ethanol is then added to remove any surfactant adhered to the carrier surface. Subsequently, the carrier from which the toner has been removed is dried in a dryer, and the above method can then be used to measure the amount of core exposure at the carrier surface.

### [Image Evaluation]

Using the modified DocuCentre Color 400 apparatus (manufactured by Fuji Xerox Co., Ltd.) shown in FIG. 1, print tests are conducted under high temperature conditions (35° C., 80% RH), by printing 50,000 copies with an image area of 10% and 3,000 copies with an image area of 5%. The image is then evaluated in terms of image densityShade, fogging, and toner density. The magnetic permeability setting Vs is set so as to yield a toner density of 9%. Control of the toner density is conducted so that when the difference between the sensor detected value V and the set value Vs, namely Δ=Vs−V is positive, the toner density is adjudged to be satisfactory, and toner supplementation is stopped, whereas when the difference Δ is negative, the toner density is adjudged to be insufficient, and toner supplementation is started, with the control process designed to limit the value of Δ.

Furthermore, the image forming method used includes: forming an electrostatic latent image on the surface of an electrostatic latent image holding member, developing the electrostatic latent image using a developer, thereby forming a toner image, transferring the toner image to the surface of a transfer target, cleaning any residual toner from the latent image holding member with an elastic cleaning blade, and heat fixing the toner image, and the process speed is set to 350 mm/second.

### <Evaluation of Image Density Shade>

A predetermined number of copies are printed with each developer under predetermined conditions, the developer is then left to stand overnight, an image having a 2 cm×5 cm patch is then copied, and 5 locations within the patch are then measured using an image densitometer (X-Rite 404A, manufactured by X-Rite, Inc.). A developer for which the difference between the maximum measured value and the minimum measured value is less than 0.5 is evaluated using the symbol A, a difference of at least 0.5 but less than 0.8 is evaluated using the symbol B, and a difference of 0.8 or greater is evaluated using the symbol C.

### <Fogging>

Each developer is used to print 10,000 copies under predetermined conditions, and the number of copies printed at the point where fogging starts to occur is evaluated visually. A developer for which no fogging occurred even after 10,000 copies is evaluated using the symbol A, a developer for which fogging occurred after between 9,000 and 10,000 copies is evaluated using the symbol B, a developer for which fogging occurred after between 6,000 and 9,000 copies is evaluated using the symbol C, and all other cases are evaluated using the symbol D.

### <Evaluation of Toner Density>

A sample of the developer to be measured, with a weight of approximately 0.30±0.05 g, is measured by the blow-off method using a charge measuring device (TB200, manufactured by Toshiba Corporation). Using the evaluation conditions described above, the toner density is measured every 100,000 copies. A measured density value within ±1.0% of the set value is evaluated using the symbol A, a measured value within ±1.5% of the set value is evaluated using the symbol B, and all other cases are evaluated using the symbol C.

TABLE 1

| | | | | | Carrier | | | | | |
|---|---|---|---|---|---|---|---|---|---|---|
| | | | Core | | | | Core | | | |
| | | | particles | | | | exposure | Image density | Fogging (within | |
| | Carrier | Toner | Sm (μm) | Ra (μm) | Ra (μm) | Sphericity | ratio (%) | Shade | 10,000 copies) | Toner density |
| Example 1 | A | A | 1.06 | 0.39 | 0.22 | 0.993 | 2 | A | A | A |
| Example 2 | A | B | 1.06 | 0.39 | 0.22 | 0.993 | 2 | A | B | A |
| Example 3 | B | A | 1.52 | 0.62 | 0.45 | 0.982 | 2 | A | B | A |
| Comparative | C | A | 1.06 | 0.39 | 0.31 | 0.972 | 4.3 | C | D | C |
| example 1 | | | | | | | | | | |
| Comparative | D | A | 1.91 | 0.85 | 0.65 | 0.991 | 3.6 | B | C | B |
| example 2 | | | | | | | | | | |
| Comparative | E | A | 0.84 | 4.39 | 0.72 | 0.973 | 5 | C | D | C |
| example 3 | | | | | | | | | | |

From the print tests above it is evident that carriers and developers of the present invention are resistant to carrier adhesion under all manner of environments, and are able to provide a combination of high image quality, in which image quality deterioration caused by localized degradation of the latent image holding member is prevented, and favorable reliability.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic latent image carrier, comprising core particles and a resin coating layer that coats a surface of the core particles, wherein
a surface roughness of the core particles exhibits a surface roughness Sm that satisfies an expression Sm≦2.0 μm and a surface roughness Ra (compliant with JIS B0601) that satisfies an expression Ra≧0.1 μm,
a surface roughness Ra (compliant with JIS B0601) of the electrostatic latent image carrier satisfies an expression Ra≦0.5 μm, and a sphericity of the electrostatic latent image carrier is approximately 0.975 or higher.

2. The electrostatic latent image carrier according to claim 1, wherein
a core exposure ratio at a surface of the electrostatic latent image carrier is approximately 2% or lower.

3. The electrostatic latent image carrier according to claim 1, wherein a core of the carrier is represented by a formula shown below:
(MO)_{X}(Fe₂O₃)_{Y}
(wherein, M comprises one or more metals selected from the group consisting of Cu, Zn, Fe, Mg, Mn, Ca, Li, Ti, Ni, Sn, Sr, Al, Ba, Co and Mo; and X and Y represent molar ratios, wherein X+Y=1.00).

4. The electrostatic latent image carrier according to claim 3, wherein M represents one or more metals selected from the group consisting of Li, Mg, Ca, Mn, Sr, and Sn, and a combined quantity of any other M components is no higher than approximately 1% by weight.

5. The electrostatic latent image carrier according to claim 1, wherein when a magnetization σ of the core particles is measured within a magnetic field of 1 kOe, using a VSM (vibrating sample method) measuring apparatus and employing a BH tracer method, a resulting magnetization value σ1000 is within a range from approximately 45 to 90 Am²/kg (emu/g).

6. The electrostatic latent image carrier according to claim 1, wherein an average particle size of the core particles is within a range from approximately 10 to 100 μm.

7. The electrostatic latent image carrier according to claim 1, wherein an electrical resistance of the carrier under a measurement electric field of 5,000 V/cm is within a range from approximately 1×10⁵ to 1×10¹⁴ Ω-cm.

8. The electrostatic latent image carrier according to claim 1, wherein a dynamic electrical resistance of the carrier, when measured in the form of a magnetic brush under an electric field of 10⁴ V/cm, is within a range from approximately 1×10³ to 1×10¹³ Ω-cm.

9. The electrostatic latent image carrier according to claim 1, wherein a thickness of the resin coating layer is within a range from approximately 0.1 to 5 μm.

10. An electrostatic latent image developer, comprising a toner and a carrier, wherein
the carrier is the electrostatic latent image carrier according to claim 1.

11. The electrostatic latent image developer according to claim 10, wherein a volume average particle size of the toner is within a range from approximately 3 to 9 μm.

12. The electrostatic latent image developer according to claim 10, wherein an average value of a shape factor SF1 for the toner is approximately 100 or greater, but no higher than approximately 135.

13. The electrostatic latent image developer according to claim 10, wherein a volume average particle size of a colorant of the toner is within a range from approximately 0.01 to 1 μm.

14. The electrostatic latent image developer according to claim 10, wherein a proportion of the toner is within a range from approximately 1 to 15% by weight of the entire developer.

15. An image forming apparatus, comprising a latent image forming unit that forms an electrostatic latent image on a surface of a latent image holding member, a developing unit that develops the electrostatic latent image formed on the surface of the latent image holding member using a developer supported on a developer carrier, thereby forming a developed image, a transfer unit that transfers the developed image formed on the surface of the latent image holding member to a surface of a transfer target, and a fixing unit that heat fixes an image that has been transferred to the surface of the transfer target, wherein the developer uses the electrostatic latent image carrier disclosed in claim 1.
